(19) United States
(12) Patent Application Publication
(10) Pub. No.: US 2025/0238693 A1
(43) Pub. Date: Jul. 24, 2025

(54) MOE MODEL FROM BLOCK SPARSE COMPUTATION'S POINT OF VIEW

(71) Applicant: TENCENT AMERICA LLC, Palo Alto, CA (US)

(72) Inventor: Dong Yu, Bothell, WA (US)

(73) Assignee: TENCENT AMERICA LLC, Palo Alto, CA (US)

(21) Appl. No.: 18/418,624

(22) Filed: Jan. 22, 2024

(51) Int. Cl. G06N 5/043; G06N 5/022

(52) U.S. Cl. CPC G06N 5/043; G06N 5/022

(57) ABSTRACT

A method and apparatus comprising computer code configured to cause a processor or processors to form one or more routers of a mixture of experts (MoE) model by computing router parameters based on a plurality of MoE weights, implement at least one of the routers of the MoE model to compute one or more outputs by using a number of the MoE weights less than that of the plurality of MoE weights, and derive an MoE expert based on iteratively updating the router parameters according to the one or more outputs.

### TECHNICAL FIELD

The present disclosure is related to derivation of a new mixture-of-experts (MOE) model from block sparse computation's point of view.

### BACKGROUND

Large-scale fully-parametric models have achieved great success in solving natural language processing (NLP) tasks and image/video processing tasks. However, they generally require a huge number of model parameters to store the necessary knowledge for solving multiple tasks in the zero/few-shot setting. Meanwhile, their problem solving capability only emerges after reaching a certain model scale. In addition, such models may be hard to adapt to the evolving world knowledge without expensive model re-training.

And for any of those reasons there is therefore a desire for technical solutions to such problems that arose in computer technology.

### SUMMARY

There is included a method and apparatus comprising memory configured to store computer program code and a processor or processors configured to access the computer program code and operate as instructed by the computer program code. The computer program is configured to cause the processor implement forming code configured to cause the at least one processor to form one or more routers of a mixture of experts (MoE) model by computing router parameters based on a plurality of MoE weights; implementing code configured to cause the at least one processor to implement at least one of the routers of the MoE model to compute one or more outputs by using a number of the MoE weights less than that of the plurality of MoE weights; and deriving code configured to cause the at least one processor to derive an MoE expert based on iteratively updating the router parameters according to the one or more outputs.

In a first input layer of a first iteration of iteratively updating the router parameters may be N=1 where N is a total number of the one or more routers.

A total number of the plurality of MoE weights may be n, and a total number of the one or more outputs of the one or more routers may be K and a total number of the MoE weights less than that of the plurality of MoE weights may be k, and updating the router parameters according to the one or more outputs may include updating the router parameters by replacing the total number of the plurality of MoE weights n total number of the MoE weights k less than that of the plurality of MoE weights n.

Deriving the MoE expert may include estimating an output block index k by computing which of a plurality of blocks has a highest sum of activations.

Computing which of the plurality of blocks has the highest sum of activations may be based on each of the plurality of blocks accumulated activations, a nonlinear activation function, the MoE weights, an input value of an input block, and a bias corresponding to the one or more outputs.

Each of the plurality of blocks accumulated activations may be sn k determined by

$${s}_{nk} = {\sum }_{j} f ( {\sum }_{i} {w}_{nk , ij} {x}_{n , i} + {b}_{nk , j} )$$

where f(.) represents the nonlinear activation function, w_{nk,ij} represents the MoE weights, x_{n,i} represents the input value of the input block, and b_{nk,j} represents the bias.

The MoE expert may be derived further based on a sum of activations of the MoE expert.

The MoE expert may be derived as one of a plurality of blocks of the MoE that is estimated as having a highest sum of activations among the plurality of blocks.

The MoE expert may be implemented in a large language model and an image model.

The MoE expert may be implemented in an image model.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other features and aspects of embodiments of the disclosure will be apparent from the following description taken in conjunction with the accompanying drawings, in which:

FIG. 1 is a schematic illustration of a diagram in accordance with embodiments;

FIG. 2 is a simplified flow diagram in accordance with embodiments;

FIG. 3 is a simplified diagram in accordance with embodiments;

FIG. 4 is a simplified flow diagram in accordance with embodiments;

FIG. 5 is a simplified diagram in accordance with embodiments;

FIG. 6 is a diagram in accordance with embodiments;

FIG. 7 is a diagram in accordance with embodiments;

FIG. 8 is a diagram in accordance with embodiments;

FIG. 9 is a diagram in accordance with embodiments;

FIG. 10 is a simplified flow diagram in accordance with embodiments;

FIG. 11 is a simplified diagram in accordance with embodiments;

FIG. 12 is a simplified flow diagram in accordance with embodiments;

FIG. 13 is a simplified diagram in accordance with embodiments;

FIG. 14 is a simplified diagram in accordance with embodiments;

FIG. 15 is a simplified diagram in accordance with embodiments;

FIG. 16 is a simplified flow diagram in accordance with embodiments;

FIG. 17 is a simplified diagram in accordance with embodiments; and

FIG. 18 is a simplified diagram in accordance with embodiments.

### DETAILED DESCRIPTION

The following detailed description of example embodiments refers to the accompanying drawings. The same reference numbers in different drawings may identify the same or similar elements.

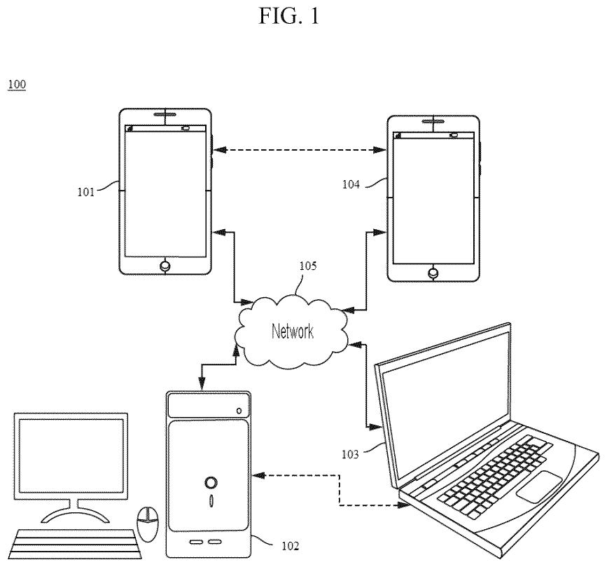

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded video data of the other terminal from the network 105, decode the coded data and display the recovered video data. Unidirectional data transmission may be common in media serving applications and the like.

FIG. 1 illustrates a second pair of terminals 101 and 104 provided to support bidirectional transmission of coded video that may occur, for example, during videoconferencing. For bidirectional transmission of data, each terminal 101 and 104 may code video data captured at a local location for transmission to the other terminal via the network 105. Each terminal 101 and 104 also may receive the coded video data transmitted by the other terminal, may decode the coded data and may display the recovered video data at a local display device.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated video conferencing equipment. The network 105 represents any number of networks that convey coded video data among the terminals 101, 102, 103 and 104, including for example wireline and/or wireless communication networks. The communication network 105 may exchange data in circuit-switched and/or packet-switched channels. Representative networks include telecommunications networks, local area networks, wide area networks and/or the Internet. For the purposes of the present discussion, the architecture and topology of the network 105 may be immaterial to the operation of the present disclosure unless explained herein below.

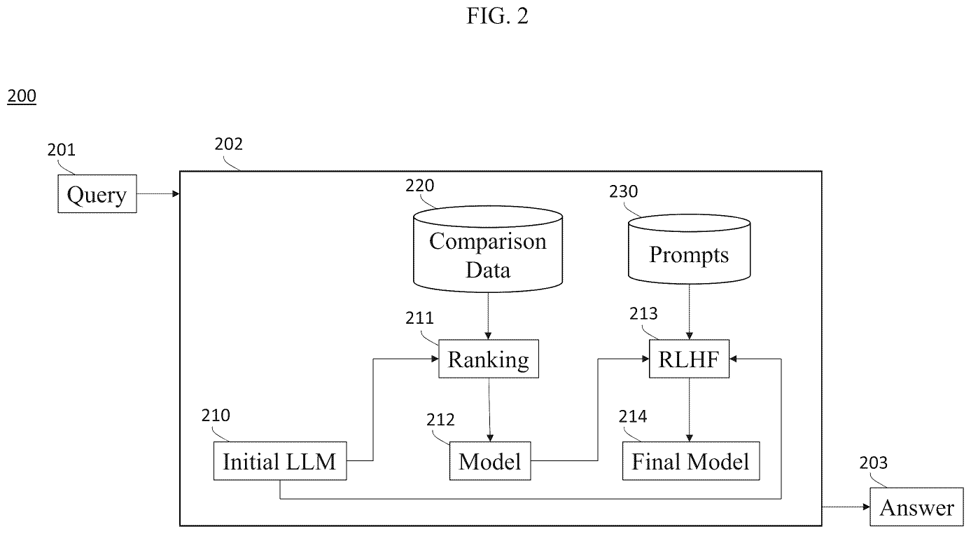

According to exemplary embodiments as shown in FIG. 2, an RLHF pipeline 200 may first train a model 212, which may be a reward model (RM) or an advantage model described further below, using standard ranking loss 211 on some comparison data 220. Each instance inside the comparison dataset, having the comparison data 220, usually contains several model outputs regarding a question, such as the query 201 to a GPT LLM or from the prompts 230, and the corresponding human-annotated ranking for the outputs, e.g., whether the human operator decided whether the answer 203 was appropriate or not. The RLHF pipeline 202 then uses the model 212 as the supervision to train the LLM to obtain the final model 213 for external use such as providing an answer 203 which could be output to a user in the form of a text, solution to a problem in the query 201, story, etc. Obviously, the model 212 serves as a critical role in the success of RLHF 213, having prompts 230 as input. The model 212 obtained by a ranking-loss training method can generally achieve quite satisfactory accuracy on the development set of reward modeling. However, if the ranking loss function only focuses on whether there is a difference, the function results in huge gaps in scores between samples from different tasks.

Accordingly, embodiments herein define the concept of “Proximal Policy Optimization (PPO) Alignment Tax” to describe a score-gap phenomenon, and it has been found by embodiments herein that Tax may be very unevenly paid (unfair) by each task. There has been found herein a significant difference between the RM means of different categories. This leads to a decrease in the stability of the training process, and even the so-called “Reward Hacking” phenomenon, such as not saying what should be said, and over-outputting what should not be said.

Therefore, embodiments may, within the context of the example 200 of FIG. 2, may directly train a model to capture Advantage (advantage) where an advantage A(s, a) is obtained by determining Q(s, a)−V(s), where s represents the state, a represents the action, Q(s, a) represents the expected reward of taking action a in state s, and V(s) represents the expected reward in state s.

Within the RLHF pipeline 202 of FIG. 2, an RM may be trained on a dataset of comparisons between several model outputs on the same input. Embodiments present labelers with K model outputs to rank. Embodiments produces

$$( \begin{matrix}K \\ 2\end{matrix} )$$

comparisons for each question shown to the annotators. After collecting all annotated data, they train on all

$$( \begin{matrix}K \\ 2\end{matrix} )$$

comparisons from each question as a single GPU-batch element. Specifically, the loss function for the reward model may be:

$$L = - \frac{1}{( \begin{matrix}K \\ 2\end{matrix} )} {E}_{( x , {y}_{c} , {y}_{r} ) ∼ D} [ log ( σ ( {r}_{θ} ( x , {y}_{c} ) - {r}_{θ} ( x , {y}_{r} ) ) ) ] \qquad Eq . 1$$

where r_{θ}(x, y) is the scalar output of the model 212 for question x and model output y with parameter θ, y_{c} is the preferred output over yᵣ and D is the dataset of human comparisons.

In a next step, the initial model M, initial LLM 210 in FIG. 2, may be finetuned using a PPO algorithm. For example, a bandit environment may adopted which presents a random question and model output to score just one time. Given the question and model output, the model 212 produces a reward and ends the episode. In addition, a per-token KL penalty from the initial model may be added at each token to mitigate over-optimization of the RM:

$$objective ( ϕ ) = {E}_{x ∼ {D}_{P P O}} [ {r}_{θ} ( x , y ) - β log ( \frac{π ( y \vert x )}{{π}^{init} ( y \vert x )} ) ] \qquad Eq . 2$$

where π is the learned RL policy and π^{init} is the initial model. The KL coefficient β serves as a regularizer to prevent the learned RL policy from being far away from the initial model.

Embodiments herein solve “PPO Alignment Tax” problems where the model 212 results in significant difference in its scores between samples from different tasks 3 which otherwise leads to a decrease in the stability of the training process, and even the so-called “Reward Hacking” phenomenon, such as not saying what should be said, and over-outputting what should not be said.

Embodiments herein may alleviate the “PPO Alignment Tax” where the RM results in significant difference in its scores between samples from different tasks. Embodiments herein further provide two main modules which may be considered advantage modeling with entropy regularizer and adaptive FTX.

According to exemplary embodiments such as regarding advantage modeling, as model 212, with entropy regularizer, the loss function for the model 212 instead may be modeled by advantage as:

$$L = - log ( σ ( {a}_{θ} ( x , {y}_{c} ) - {a}_{θ} ( x , {y}_{r} ) ) ) - {\sum }_{y ∈ p ( x )} log ( \vert {r}_{θ} ( x , y ) - E [ {r}_{θ} ( x , y ) ] \vert - m ( x ) ) \qquad Eq . 3$$

where the first term −log (σ(a_{θ}(x, y_{c})−a_{θ}(x, yᵣ))) is the same as RM training described above in FIG. 2, and the later term models the average model performance for input question x, such as from the query 201 or prompts 230.

Fully-parametric language models generally require a huge number of model parameters to store the necessary knowledge for solving multiple natural language tasks in zero/few-shot settings. In addition, it is hard to adapt to the evolving world knowledge without the costly model re-training. Embodiments relate to a novel semi-parametric language model architecture, Knowledge-in-Context (KiC), which empowers a parametric text-to-text language model with a knowledge-rich external memory. In some embodiments, the external memory contains six broad categories of different knowledge types: entity, dictionary, commonsense, event, script, and causality knowledge. For each input instance, the KiC model adaptively selects a knowledge type and retrieves the most helpful pieces of knowledge. The input instance along with its knowledge augmentation is fed into a text-to-text model (e.g., T5) to generate the output answer, where both the input and the output are in natural language forms after prompting. Interestingly, we find that KiC may be identified as a special MoE model, where the knowledge selector plays the role of a router that is used to determine the sequence-to-expert assignment in MoE. This key observation inspires the development of a novel algorithm for training KiC with an instance-adaptive knowledge selector. As a knowledge-rich semi-parametric language model, KiC only needs a much smaller parametric part to achieve superior zero-shot performance on unseen tasks. By evaluating on 40+ different tasks, the results show that KiC_{Large} with 770 M parameters easily outperforms large language models (LMs) that are 4-39× larger by a large margin. Embodiments demonstrate that KiC exhibits emergent abilities at a much smaller model scale compared to the fully-parametric models.

In embodiments, a wide range of natural language tasks may benefit from adding knowledge, where different knowledge resources help with different subsets of tasks. For example, an experimental analysis shows that 31 out of 35 natural language tasks benefited from added knowledge. Interestingly, some tasks are even improved by 10%+ after adding suitable knowledge. To adaptively utilize knowledge, embodiments may exploit KiC to dynamically identify the most useful knowledge pieces for each input instance from a certain task and places them in the current context for answering the question. Some embodiments adopt a single text-to-text transformer (e.g., T5) to generate the output answer from the input. The retrieved knowledge pieces are appended to the input instance and converted into a natural language sequence with prompt templates. The input is then fed into the text-to-text model to generate the output answer (also in natural language). The major advantage of such a text-to-text paradigm is that it handles multiple natural language tasks with the same interface and can also generalize to unseen tasks. This training paradigm is suitable for the model design as it can teach the KiC model to learn how to select and use knowledge through various seen language tasks and then generalize well to use knowledge for solving unseen tasks. The experimental analysis further shows that such instance-adaptive (context-dependent) knowledge augmentation is critical to the success of KiC model. However, due to the inherent discrete nature, it is difficult to train KiC in a fully differentiable manner to select the correct knowledge category for each instance. To solve this problem, the KiC may be reformulated as a special MoE model, where the knowledge selector is identified as the router that is used to determine the sequence-to-expert assignment in MoE. Furthermore, the memory partition corresponding to each knowledge category together with the text-to-text model may be recognized as a special semi-parametric expert in MoE. This key observation inspires the development of a novel learning algorithm to train KiC with instance-adaptive knowledge selection capabilities.

In some embodiments, the KiC language model augments a parametric text-to-text Transformer (backbone) model with a knowledge-rich external memory. Overall, KiC consists of the following modules: (i) a parametric text-to-text backbone, (ii) an external knowledge memory with a retriever, and (iii) a knowledge selector. For each input instance, the knowledge selector first selects a particular knowledge category based on the input context and then retrieves the most helpful knowledge pieces for solving the current problem. The retrieved knowledge is used to complement the input context via concatenation, which is further converted into a natural language sequence using prompt templates. Then, the prompted textual inputs are fed into the text-to-text backbone model, which generates the output solution in natural language. The text-to-text backbone model may be any encoder-decoder models (e.g., T5, BART) or decoder-only models (e.g., GPT, PaLM). For convenience and without loss of generality, T5 is the backbone model throughout the disclosure.

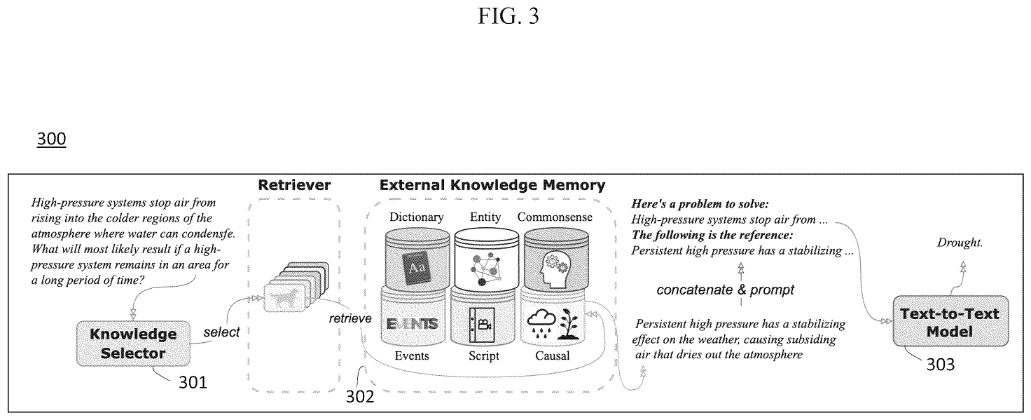

FIG. 3 is an overview of a KiC model architecture 300 according to some embodiments. The KiC model 300 is augmented with a knowledge-rich memory 302 that contains diverse categories of knowledge. For each input instance, KiC first selects a particular knowledge category using knowledge selector 301 and retrieves the most helpful knowledge pieces to augment the input. It then feeds the prompted input into a text-to-text backbone module 303 (e.g., T5) to generate the output answer.

A significant advantage of semi-parametric models over fully-parametric ones is that semi-parametric models may flexibly change the knowledge resources. Structured knowledge resources may often provide more relevant and accurate knowledge than plain text. In some embodiments, the following popular representative knowledge resources are included.

TABLE 1

| | | Common- | | | | |
|---|---|---|---|---|---|---|
| | Dictionary | sense | Entity | Event | Script | Causal |
| # instances | 1.8M | 600K | 257M | 6.4M | 248K | 314M |
| type | human | human | human | auto | auto | auto |

Dictionary: Dictionary is consider (lexical) knowledge, which records definitions and example sentences of English words. In some embodiments the largest open-source dictionary Wiktionary1 is leveraged as the lexical knowledge resource. The Wiktionary dump dated Apr. 30, 2022 that contains 1.3 M word senses and 470K example sentences for 1 M words/phrases is used.
Commonsense: Besides the lexical knowledge, commonsense knowledge is included from ConceptNet (Liu & Singh, 2004), which covers broad knowledge in daily life. In ConceptNet, all knowledge are in the format of triplets with human-defined relations (e.g., “bird”-CAPABLEOF-“fly”). The core 600K high-quality triplets are included.
Entity: Named entity knowledge is covered in Wikipedia and Wikidata. Given an entity (e.g., “UnitedStates”), each property of it is converted to be a separate triplet (e.g., “United States”-CAPITAL-“Washington D.C.”) such that the format is same as other knowledge resources. In addition to structured entity knowledge, all Wikipedia sentences related to the entity are included.
Event: Knowledge about daily events are covered with human-constructed (i.e., ATOMIC and GLUCOSE) or auto-extracted event knowledge graphs (i.e., ASER). Similar to commonsense knowledge, all event knowledge graphs store knowledge in the triplet format, where relations are human-defined or discourse relations, the head and the tail are events. An ASER example is “I am hungry”-BEFORE-“I eat food”.
Script: Besides the knowledge covered by pre-defined relations, script knowledge is also included to cover more complex ones. 325K pieces of script knowledge is used, each containing a pair of related verbal and nonverbal information (e.g., “Of course not. I'm going . . . to his house. “and “thinking”) as well as the context where they situate. Given a query, the most relevant scenario is retrieved as external knowledge.
Causality: The last external knowledge resource included is the auto-extracted causal knowledge CausalBank, which collects large-scale English sentences expressing cause-effect relations. CausalBank consists of 133 M because mode sentences (i.e., sentences captured by 12 patterns such as “because”, “caused by”, etc.) and 181 M therefore mode sentences (i.e., sentences captured by 19 patterns such as “therefore”, “result in”, etc.).

Although the effectiveness of knowledge such as entity and dictionary knowledge has been demonstrated on a wide range of tasks, other types of knowledge such as commonsense and script knowledge are only used for carefully selected tasks that tend to require these types of knowledge.

In some embodiments, the target word is used as the key and definition as the value for dictionary knowledge and every utterance as the key and the background context as the value for script knowledge. To effectively retrieve knowledge from the other four knowledge resources, dense retrieval techniques are used. All knowledge pieces are converted into natural language sentences as values (e.g., I am hungry before I eat food.) and then encoded into dense vectors as keys using a SOTA sentence encoder MPNet. Given a query, the retriever encodes it with the same sentence encoder model and then retrieves the most relevant knowledge with the maximum inner product search (MIPS) search which is able to reduce search complexity from O(n) to O(log n). In KiC, SCaNN is employed as the MIPS search algorithm.

In embodiments, for a particular task, some knowledge categories help the performance while others might hurt. For this reason, it may be desirable to dynamically select the correct knowledge type in order to facilitate the solution of the problem. In the embodiments, instead of using task-dependent knowledge selection, a more fine-grained instance-dependent strategy is considered: The knowledge is adaptively chosen based on each input instance.

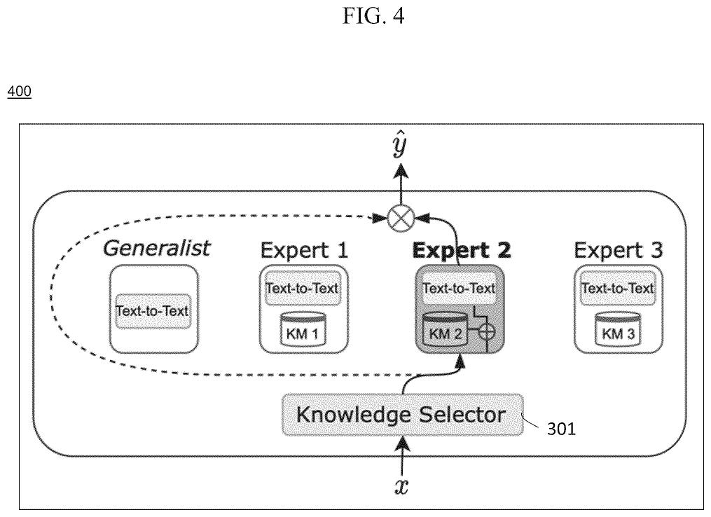

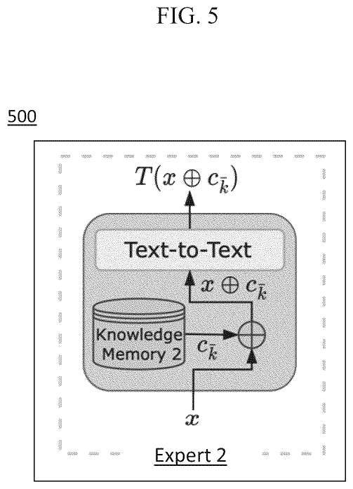

FIG. 4 shows how the KiC model may be equivalently formulated as MoE architecture 400. The knowledge selector 301 may be identified as a router that is used to determine the sequence-to-expert assignment in MoE. Each expert, for example Expert 1, Expert 2, and Expert 3, is made up of the (shared) text-to-text model and the external memory of a particular knowledge category, illustrated as knowledge memory (KM) 1, KM 2, and KM3. Therefore, each expert is in itself a stand-alone semi-parametric language model specialized in a certain type of knowledge. To allow the option of not using any knowledge, a “generalist” module is included, which is the (shared) text-to-text model alone. FIG. 5 shows an example arrangement 500 of Expert Model 2, according to embodiments.

The discrete decision made by the knowledge selector 301 will seep into the overall neural architecture in the form of a discrete latent variable. There could be several alternative methods (such as reinforcement learning) for learning the model with discrete latent variables. In some embodiments, a simple yet effective approach is developed for learning KiC in a fully-differentiable end-to-end manner. The key idea is based on an important observation that KiC may be reformulated as a special one-layer mixture-of-experts architecture. The knowledge selector 301 may be identified as the router that is used to determine the sequence-to-expert assignment in MoE. This is slightly different from the settings of the recent MoE works, where their routers perform token-to-expert assignments. Meanwhile, each expert is made up of the text-to-text module together with a particular category of knowledge memory. Interestingly, each expert is in itself a stand-alone semi-parametric language model, which retrieves a particular kind of knowledge from its own memory to augment its inputs. In other words, each expert may be understood as a specialist with expertise in a specific knowledge category. A special expert named generalist is included, which is used to handle situation where there is no need for knowledge from the memory. Furthermore, due to the original KiC design, the text-to-text modules in all the experts (and the generalist) share the same model parameters with the only difference being the non-parametric parts (i.e., the knowledge memories).

Inspired by the above KiC-MoE equivalence, a fully-differentiable learning strategy is developed for KiC by leveraging existing MoE learning approaches. In some embodiments, the knowledge selector S(x) is modeled as a (K+1)—way classifier, which outputs a (K+1)—dimensional normalized probability vector. Its k-th element, denoted as Sk(x), represents the probability of choosing the k-th knowledge category for k=0, 1, . . . , K, where k=0 represents the choice of generalist (i.e., no external knowledge). Let T (·) denote the text-to-text transformer and ck be the knowledge retrieved from the k-th category. in KiC, the top-1 knowledge category is selected according to S(x) and the output is computed. Currently, only the top-1 knowledge selection (routing) is considered for simplicity and the generalization is left to top-n selection as future work. Finally, similar to MoE, an auxiliary load balancing loss is added together with the standard cross-entropy loss during KiC learning.

Without a load balancing term, the knowledge selector 301 tends to select only one knowledge category throughout the entire training process, which was also observed in MoE learning. There could be different choices of the load balancing loss, which encourage the diversity of knowledge selection in different ways based on S(x). Without loss of generality, the same load balancing loss is used as in SwithTransformer.

The above KiC-MoE equivalence may also lead to interesting observations that could potentially benefit the studies of both semi-parametric language models and MoEs. For example, in MoE works, the experts are generally designed to be different parametric neural modules (e.g., different MLPs). However, the present disclosure shows that this may not be the only option: different experts may be constructed using the same parametric module but with different inputs.

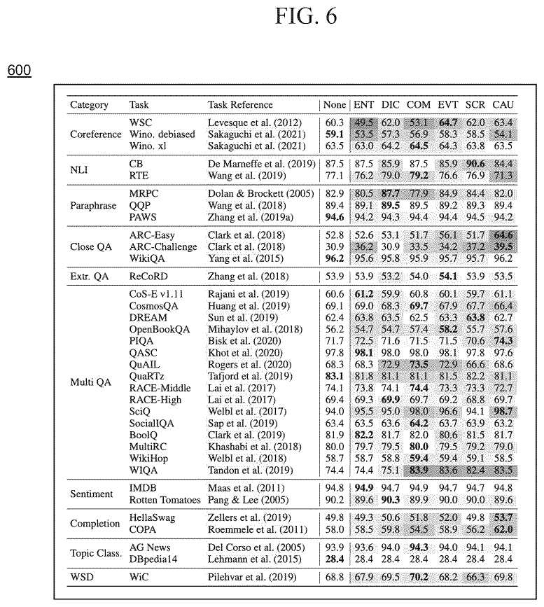

To verify the assumption that external knowledge resources may facilitate LMs in general language understanding and see effects of using different types of knowledge, single-task fine-tuning experiments were conducted on a wide range of downstream tasks, according to embodiments. FIG. 6 is a table 600 of 35 tasks evaluated and classified into 10 categories following the P3 task categorization framework. For each knowledge type (each column), all retrieved knowledge texts are appended in front of the input sentence by adding a special token in between. Next, the augmented input sentences are fed into the standard text-to-text model (T5) to generate the target answer for optimization, where training instances are from each single task. FIG. 6 shows that the model performances on 30 out of 35 tasks are improved after adding at least one type of knowledge, which demonstrates the effectiveness of using high-quality external knowledge. Based on these results, KiC is leveraged to dynamically identify the most useful knowledge pieces to adaptively utilize knowledge.

The main model KiC is initialized with T5-LM-adapt, an improved version of T5 that continues training T5 for additional 100K steps on the LM objective to leverage its ability to generate natural language. Similar to T0, the KiC model is trained on a mixture of multiple tasks (39 tasks in total) by combining and shuffling all training instances from different tasks (8.4 M in total) and predict on unseen (held-out) tasks to evaluate zero-shot generalization ability. The final KiCLarge model is trained using 128 NVIDIA V100 GPUs for 42 hours.

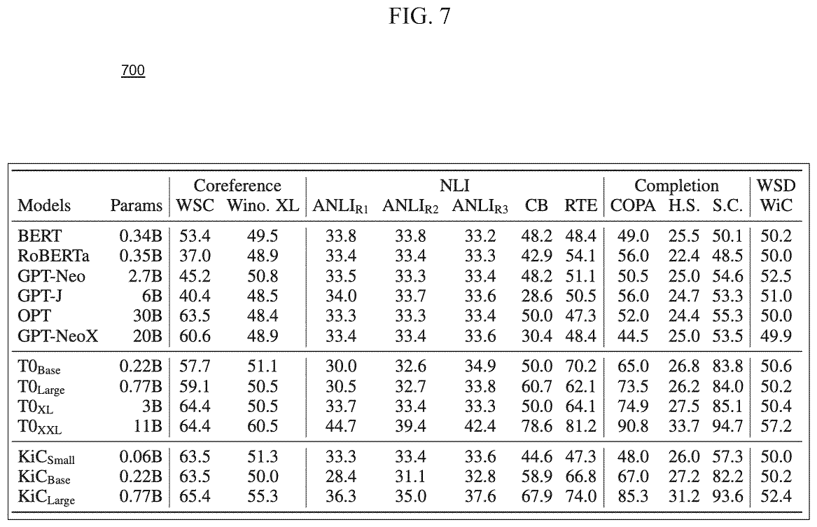

FIG. 7 is a table 700 showing the results of the KiC model evaluated on two groups of zero-shot datasets. 1) Held-out tasks of P3 contain two coreference tasks, three NLI tasks, three sentence completion tasks and one word sense disambiguation (WSD) task. Results show that the KiCLarge model outperforms all zeroshot baseline models (e.g., GPT-NeoX, OPT) that are 25-38× larger. Moreover, KiCLarge beats TOXL that has 3B parameters on all 9 tasks by a large margin with our adaptive knowledge selector and only 0.77B parameters. 2) Massive Multitask Language Understanding (MMLU) benchmark is designed to measure knowledge acquired in model pretraining. MMLU covers 57 subjects under four categories, i.e., STEM, Humanities, Social Sciences and Other. Comparison with SOTA LMs are shown in the following table. The KiCLarge beats all fine-tuning baseline models RoBERTaLarge and GPT-2 without using any training data from MMLU. Surprisingly, KiCLarge achieves an average performance of 39.4% using only 0.77B parameters, which is just 4.5% below GPT-3 that has 175B parameters (227x larger) plus 5 training examples.

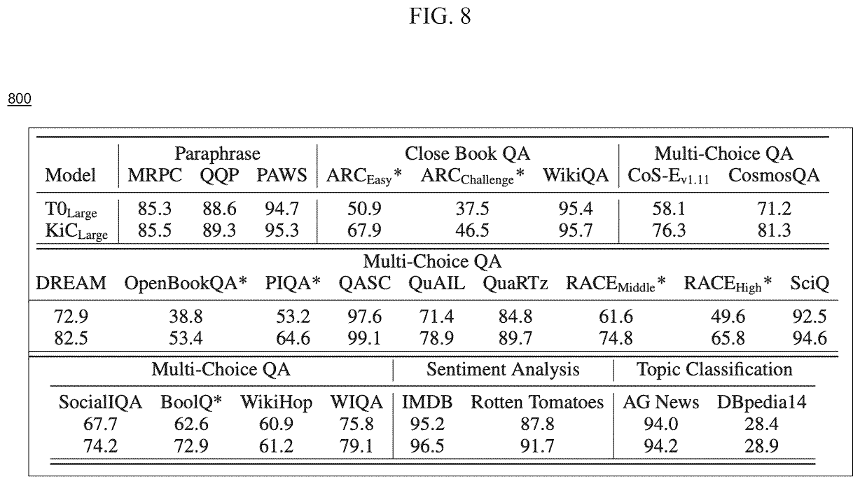

To see whether the KiC learning may help with multi-tasking training, T0Large is reproduced with the same collection of tasks and evaluated KiCLarge on the validation set of each in-domain task. FIG. 8 is a table 800 showing the results of the evaluation. Here, in-domain tasks may be divided into two groups—tasks used in multitask training and tasks not used in multitask training but within the observed task category. Again, KiCLarge outperforms T0Large, with significant improvement on in-domain unseen tasks (tasks with *) such as Race and BoolQ and knowledge-intensive tasks such as CosmosQA and DREAM. The results demonstrate the superiority of the proposed KiC learning in multi-tasking training.

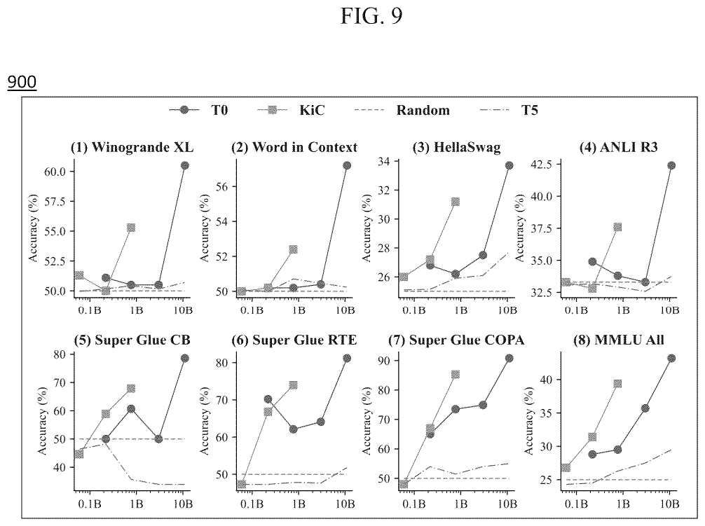

Language models usually may only perform a near random zero/few-shot performance when they are small but achieves a substantial performance jump when they reach a certain critical threshold of scale (size). A language model is generally considered superior if it can show emerging behavior at a smaller model scale. Therefore, the KiC model is compared with T5 and TO on held-out tasks to see how performance change with respect to their model sizes. FIG. 9 contains an example 900 comparing the performance of the KiC model with T5 and TO. T5 is around random guess when the model is below 11B. TO is better than T5 as it shows emerging behavior when it increases from 3B to 11B. Surprisingly, the KiC model shows emerging behavior when it increases from 0.22B to 0.77B, which demonstrates that the semi-parametric model may achieve the same language understanding capacity using much fewer parameters with the help of adaptive knowledge selector and external knowledge.

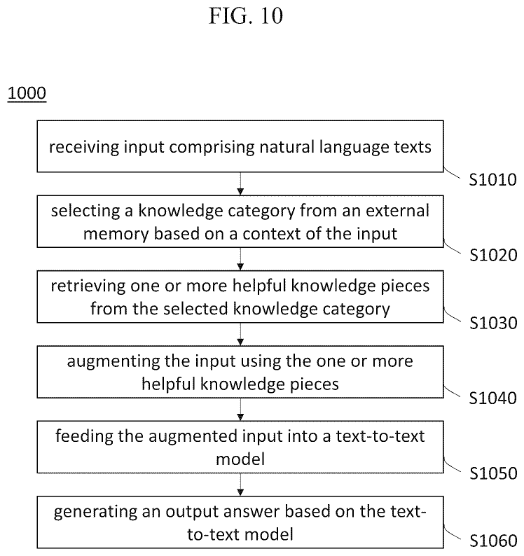

FIG. 10 is a flowchart of example process 1000 for semi-parametric language modeling aided by Knowledge-in-Context. In some implementations, one or more process blocks of FIG. 6 may be performed by any of the elements discussed above.

As shown in FIG. 10, process 1000 include receiving an input comprising natural language texts at S1100

As further shown in FIG. 10, the process 1000 may include selecting, via a knowledge selector, one of a plurality of knowledge categories from an external memory based on a context of the input at S1020.

As further shown in FIG. 10, the process 1000 may include retrieving one or more helpful knowledge pieces from the selected knowledge category at S1030.

As further shown in FIG. 10, the process 1000 may include augmenting the input using the one or more helpful knowledge pieces at S1040.

As further shown in FIG. 10, the process 1000 may include feeding the augmented input into a text-to-text model at S1050.

As further shown in FIG. 10, the process 1000 may include generating an output answer based on the text-to-text model at S1060.

Although FIG. 10 shows example blocks of process 100, in some implementations, process 1000 may include additional blocks, fewer blocks, different blocks, or differently arranged blocks than those depicted in FIG. 10. Additionally, or alternatively, two or more of the blocks of process 1000 may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

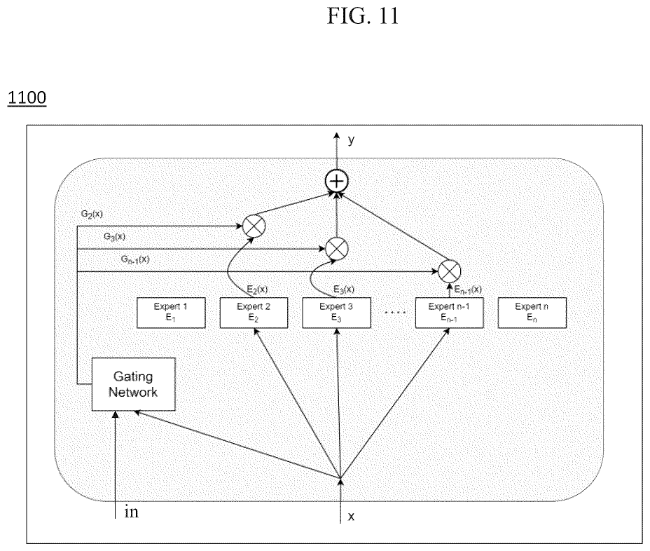

Embodiments are based on the sparsely-gated MoE network. As described herein, the MoE network according to embodiments is a network architecture that uses a large number of experts to process the input data and uses a gating network to conditionally select a subset of the experts and the corresponding weightings to compute the result applied to the task of language modeling and machine translation model. The MoE network consists of multiple instances of experts, each with a different set of parameters, and a gating function, for example, see example structure 1100 of FIG. 11. The network consists of two main parts: the experts and the gating network. There are n number of experts in total, E₁, E₂ . . . Eₙ, each with a different function to process the input image block. For each input sample, the gating network decides for that sample which of the k experts and the corresponding weights are to be used to process the input sample. Then the outputs from the k selected experts are combined as the final output using the corresponding weights as the final output.

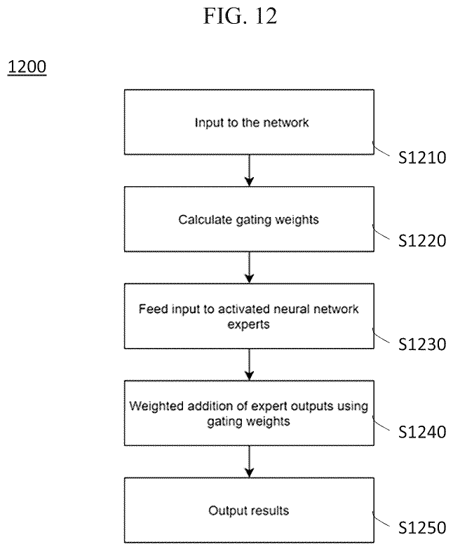

An example operational flowchart 1200 of the network structure 1110 is shown in FIG. 12. For each input x, at S1210, a random number StandardNormal( ) is drawn from the Gaussian distribution with zero mean and unit variance. The input x is first passed to the gating function to, at S1220, calculate the gating weights G(x) using equation (4), (5) and (6), where W_{g} and Wₙₒᵢₛₑ are trainable matrices by:

$${H ( x )}_{i} = {( x \cdot {W}_{g} )}_{i} + StandardNormal ( ) \cdot Softplus ( {( x \cdot {W}_{n o i s e} )}_{i} ) \qquad Eq . 4$$

$$G ( x ) = Softmax ( KeepTop K ( ( H ( x ) , k ) \qquad Eq . 5$$

$${KeepTopK ( v , k )}_{i} = \{ \begin{matrix}{v}_{i} & if {v}_{i} is in the top k elements of v . \\ - ∞ & otherwise .\end{matrix} \qquad Eq . 6$$

where the vector G(x) is a n-dimensional sparse vector with k non-zero elements. If an element G(x) is non-zero, the corresponding expert Eᵢ is activated.

When the expert outputs are calculated, the gating weights are used to combine the expert outputs through a weighted addition using equation (7). The combined output y is the final output of the MoE network.

$$y = {\sum }_{i = 1}^{n} {G ( x )}_{i} {E}_{i} ( x ) \qquad Eq . 7$$

The MoE network of embodiments described above may be described in the context of language modeling and machine translation, embodiments herein may also apply to processing image and video data. In the processing of image and video data, the data may be 2-dimensional and may has multiple channels. And in the MoE for image and video processing, the experts and gating function of the MoE are redesigned for image and video data using convolution as the main operation.

For example, according to embodiments, the “in” in example 1100 of FIG. 11, may relate, in image and video coding, to quantization parameter (QP) which is a parameter that controls the quality of the decoded image. Therefore, QP is an important parameter in deciding how to filter a decoded image to improve picture quality. Either the value of QP may be used to select one expert from a multiple of experts or the QP is also used as input to an expert, so that a single network can be trained to filter images of different QP.

This filtering network may have some key differences according to embodiments. This network takes 2-dimensional image data as input and outputs filtered 2-dimensional image data. Convolutional neural networks are used in the experts and the gating function, as oppose to the matrices W_{g} and Wₙₒᵢₛₑ used in language modeling and machine translation in equation (4),(5), and (6). As shown in example 1100 of FIG. 11, the gating function of this network takes both the image block and QP of the decoded image as inputs, and it uses a neural network structure instead of a matrix multiplication. It combines both 2-dimensional image data and a scalar value to compute an n-dimensional vector for expert activation and weighting.

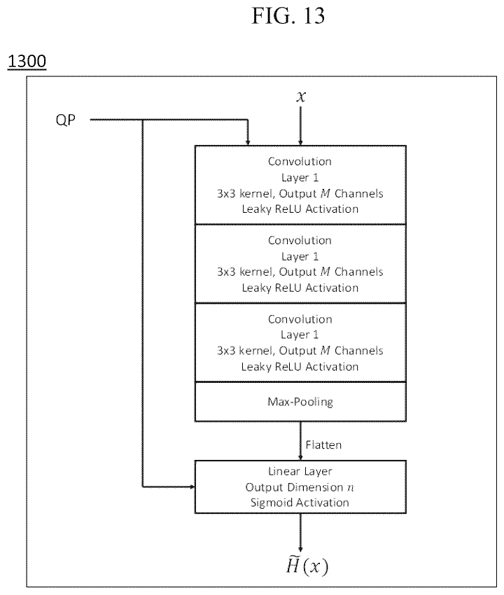

According to exemplary embodiments, as in example 1300 of FIG. 13, the gating network consist of three convolution layers, one max-pooling layer, and one linear logistic regression layer. It takes a 3-channel image and QP as inputs. The QP is concatenated with the 3-channel image to form a 4-channel image. The first convolution layer takes the 4-channel image as input and output a M-channel output, for example, M=32. The second and third convolution layers both takes a M-channel input and output a M-channel output. All convolution layers use a kernel size of 3×3 and are activated by the Leaky ReLU function. A max-pooling layer takes the M-channel feature map as input and down-sample the feature map through a max-pool operation using 2×2 kernel with a stride of 2. The resulting down-sampled feature map is flattened to a vector and concatenated with the QP value. This vector is given to the linear logistic regression layer to calculate an n-dimensional vector H(x).

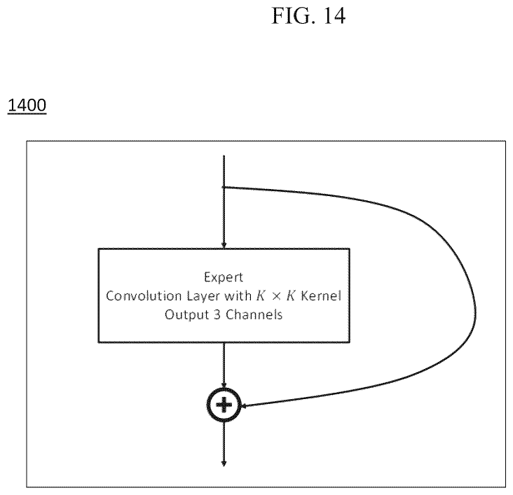

The output of the gating function is used to determine which experts are activated. A vector G(x) is calculated using equation (8), (9) and (10). The vector G(x) is a sparse vector with k non-zero elements. If the element G(x) is non-zero, the corresponding expert Eⱼ is activated, otherwise the element G(x)₁ is zero and the corresponding expert Eⱼ is not activated.

$${H ( x )}_{i} = {\tilde{H} ( x )}_{i} + StandardNormal ( ) \cdot Softplus ( {( \tilde{H} ( x ) \cdot {W}_{n o i s e} )}_{i} ) \qquad Eq . 8$$

$$G ( x ) = Softmax ( KeepTop K ( ( H ( x ) , k ) ) \qquad Eq . 9$$

$${KeepTopK ( v , k )}_{i} = \{ \begin{matrix}{v}_{i} & if {v}_{i} is in the top k elements of v . \\ - ∞ & otherwise .\end{matrix} \qquad Eq . 10$$

where when the trainable matrix Wₙₒᵢₛₑ is not zero, G(x) in Equation (8) is not deterministic, and therefore the network architecture can only be used for post-filtering. When the trainable matrix Wₙₒᵢₛₑ is forced to be zero in the training process, G(x) becomes deterministic and the network architecture can be used for in-loop filtering. When it is used for in-loop filtering, G(x) is calculated using equation (10) and (11), where H(x) is the output from FIG. 13:

$$G ( x ) = Softmax ( KeepTop K ( ( \tilde{H} ( x ) , k ) ) \qquad Eq . 11$$

where there are n number of experts. The structure of each expert consists of one convolution layer with a K x K kernel with no output activation layer as shown example 1400 of FIG. 14. Each expert take a 3-channel image and filter it with the convolution layer. To ease the training process, a residual connection is used to add the input image to the output of the convolution layer to obtain E₁(x), the output of the expert. In one implementation, K is selected to be 7 to match the BALF filter size in VVC.

Returning to the example 1200 of FIG. 12, like in language processing, example 1200 may also represent image processing where there may be image block and QP being first input to the gating function to calculate gating weights. The image block is then given to the activated experts, where each expert filters the input image block. When the expert outputs are calculated, the gating weights are used to combine the expert outputs through a weighted addition using equation (7). The combined output y is the final output of the MoE network.

Therefore, according to embodiments, an application of the method of mixture of experts (MoE) to noise reduction in video processing is provided. In this disclosure, a FIR filter is interpreted as an expert for improving picture quality of an M₁×M₂ block in which the in-loop filter takes quantization parameter (QP) and a N₁×N₂ neighbourhood of the M₁×M₂ block as inputs, then based on the N₁×N₂ neighbourhood and QP, it selects k experts from n pre-determined experts and computes weightings of the k experts, where k >1, then compute the outputs from the k experts. Each expert outputs one M₁×M₂ block, and then compute the output of the in-loop filter as a linear combination of the outputs of the k selected experts using the computed weighting of the k experts for the linear combination. Key contributions of such embodiments according to the disclosure include the following: quantization parameter is used as one of the inputs to the gating network, based on the quantization parameter, the gating network selects k filters from the n pre-determined filters, where k >1, and determines the corresponding weights, and although the weights from the gating networking are functions of QP, the filter coefficients of the n pre-determined filters are not functions of QP.

When the experts are FIR filters according to embodiments, such embodiments can be implemented more efficiently as: the in-loop filter takes quantization parameter (QP) and a N₁×N₂ neighbourhood of the M₁×M₂ block as inputs, then based on the N₁×N₂ neighbourhood and QP, it selects k FIR filters from n pre-determined FIR filters and computes weightings of the k FIR filters, where k >1, then compute a combined FIR filters as a linear combination of the k selected FIR filters using the computed weighting of the k FIR filters for the linear combination, and then compute the output of the in-loop filter as the outputs of the combined FIR filter using the N₁×N₂ neighbourhood as input. According to exemplary embodiments, in this more efficient implementation, computation is reduced by replacing k convolutions by one convolution.

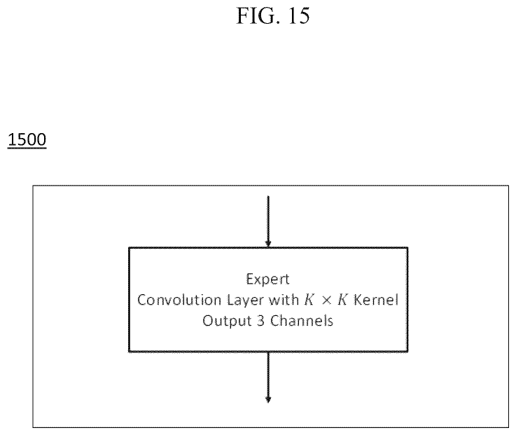

Further, the example 1500 shown in FIG. 15, expert network from FIG. 14 may be replaced by the expert network in FIG. 15. According to embodiments, the expert network may use convolutional layers to filter the input image. The experts can be alternatively implemented using different setups of convolution layers. Possible alternatives include multiple number convolutional layers with multiple intermediate channels, different sizes of convolution kernels, different activation functions, and options of using the residual connection according to embodiments herein.

In general, the gating network according to embodiments needs to take the image and QP as input and output an n-dimensional vector with at most k non-zero components. It can be alternatively implemented using different number of convolution layers, different number of intermediate channels, different activation functions. In addition to the one linear layer logistic regression, a multi-layer neural network can be used. The QP value can also be concatenated to any point in the gating network as input to any layer in the gating network.

Also, be it image/video processing or language processing according to embodiments herein, embodiments herein consider that block sparse approximation is equivalent to adding block-wise lateral inhibition in the system. Which may cause a small gap against the original dense layer but should be close enough to exploit the sparse property of the dense layer. And in such situations, it may be considered how to determine the expert.

Embodiments herein provide a solution by choosing the block with the highest sum of activations for both input and output layers. According to embodiments, an input block index n may be known before hand, e.g., from previous layer's computation, and as such, embodiments may need only to estimate the output block index k given the input block index n and the input values xn in the n-th input block.

For example, according to embodiments, the output block index k may be estimated by computing which block has a highest sum of activations by:

$${s}_{nk} = {\sum }_{j} f ( {\sum }_{i} {w}_{nk , ij} {x}_{n , i} + {b}_{nk , j} ) \qquad Eq . ( 12 )$$

where sₙₖ may be the k'th block's (given input block n) accumulated activation, f(.) may be the nonlinear activation function, w_{nk,ij} may be the n-k-th expert's weights, x_{n,i} may be the i-th input value of the input block n, and b_{nk,j} may be the bias corresponding to the j-th output in the n-k'th expert.

However, since the activation function may be nonlinear according to exemplary embodiments, there may be technical difficulty in computing sₙₖ which, according to embodiments, is solved by relaxing sₙₖ by removing the non-linear activation functions and being replaced with:

$${r}_{nk} = {\sum }_{j} ( {\sum }_{i} {w}_{nk , ij} {x}_{n , i} + {b}_{nk , j} ) = {\sum }_{j} {\sum }_{i} {w}_{nk , ij} {x}_{n , i} + {\sum }_{j} + {b}_{nk , j} = {\sum }_{j} ( {\sum }_{i} {w}_{nk , ij} ) {x}_{n , i} + {\sum }_{j} + {b}_{nk , j} \qquad Eq . 13$$

Eq. 13 according to embodiments shows that there is a very efficient method to estimate the output block. For example, once the weights and biases for the n-k'th expert are obtained, then the embodiments may need only to sum the weights and biases over the output index j to form a new weight and bias, e.g., the weights (Eq. 14) and biases (Eq. 15) of the linear router are:

$${\overline{w}}_{nk , i} = {\sum }_{j} {w}_{nk , ij} \qquad Eq . 15$$

$${\overline{b}}_{nk} = {\sum }_{j} {b}_{nk , j}$$

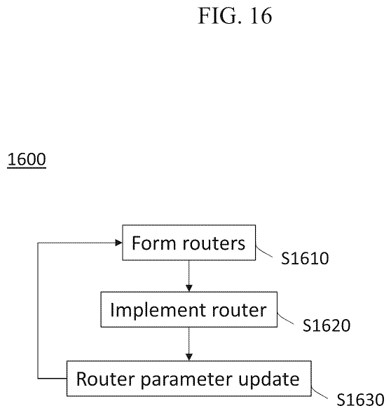

For example, according to embodiments, a procedure, as shown in example 1600 of FIG. 16 is as follows. Given the random weights, compute the router parameters using the above equations to, at S1610, form N routers each with K outputs. Then, at S1620, the router may be implemented to decide the output block k and only use n-k'th weights to compute the output. Now, as a router parameter update in S1630, k becomes n in the next layer and this process can be continued. After each gradient descent step the router parameters are updated again using the above equations.

According to embodiments, the first input layer should have N=1 (i.e., do not use block). Embodiments may usually observe that the sparseness degree is smaller in layers closer to the raw input, and for such reason, embodiments may use less blocks there. Embodiments may are further validated with better ideas on the sparseness degrees by checking the existing models we have. Wider networks usually have higher sparseness degrees according to embodiments.

According to embodiments, there is shown here that embodiments may use only one continuous block in both input and output. But embodiments employ the same idea when using more than one continuous blocks, e.g., when 2 blocks are chosen in both input and output layers by using 2×2=4 experts.

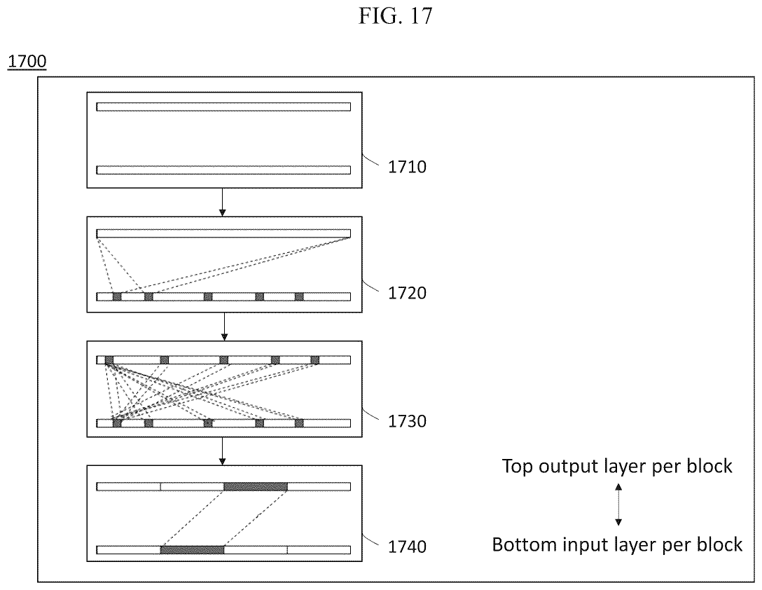

Therefore, by example 1600 of FIG. 16, see a more graphical illustration 1700 in FIG. 17 where for block 1710, there may be an output layer (top) and an input layer (bottom), then from block 1710 to block 1720, there may be an activation in sparse such that computational complexity is reduced. As such, at block 1720, although W: Ds1×D may not be regular and not efficient, and input sparse (bottom) may have non-zero values known as described above, from block 1720 to block 1730, since the output nodes may be known to be non-zero in advance, further reduction is possible to the output layer (top) of block 1730 which represents an output parse with non-zero values unknown. And in block 1730, with W: Ds1×Ds2 (not regular, not efficient) and with input layer (bottom) sparse with non-zero values unknown, there may be a speeding up in computation from block 1730 to block 1740 by assuming (and forcing during training) that non-sparse activations are within blocks. As such, at block 1740, the output layer (top) block sparse, K blocks and the input layer (bottom) with block wise sparse, N blocks, may have W: Ds1×Ds2 (regular, efficient) such that this block represent an MoE of which each matrix, or expert, has two indexes: input block n and output block k, thereby totaling N×K experts according to embodiments herein.

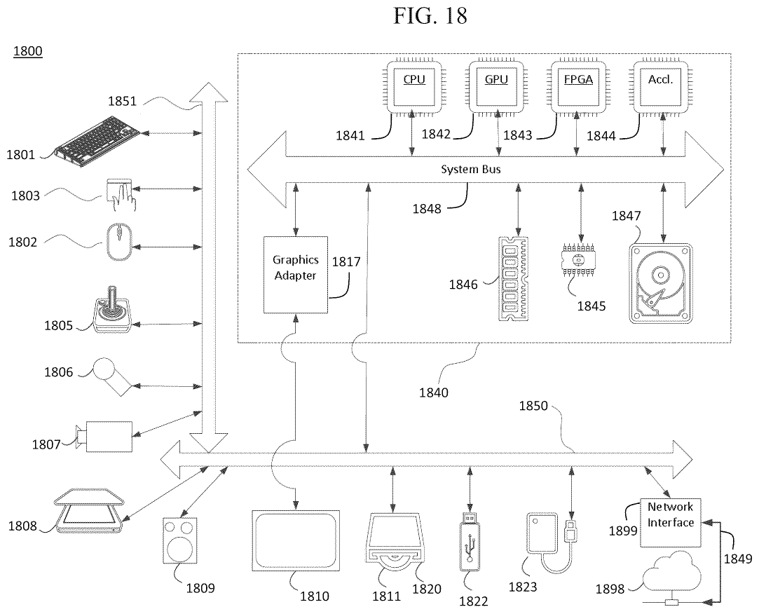

The techniques described above, can be implemented as computer software using computer-readable instructions and physically stored in one or more computer-readable media or by a specifically configured one or more hardware processors. For example, FIG. 18 shows a computer system 1800 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 18 for computer system 1800 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 1800.

Computer system 1800 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 1801, mouse 1802, trackpad 1803, touch screen 1810, joystick 1805, microphone 1806, scanner 1808, camera 1807.

Computer system 1800 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1810, or joystick 1805, but there can also be tactile feedback devices that do not serve as input devices), audio output devices (such as: speakers 1809, headphones (not depicted)), visual output devices (such as screens 1810 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 1800 can also include human accessible storage devices and their associated media such as optical media including CD/DVD ROM/RW 1820 with CD/DVD 1811 or the like media, thumb-drive 1822, removable hard drive or solid state drive 1823, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1800 can also include interface 1899 to one or more communication networks 1898. Networks 1898 can for example be wireless, wireline, optical. Networks 1898 can further be local, wide-area, metropolitan, vehicular and industrial, real-time, delay-tolerant, and so on. Examples of networks 1898 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 1898 commonly require external network interface adapters that attached to certain general-purpose data ports or peripheral buses (1850 and 1851) (such as, for example USB ports of the computer system 1800; others are commonly integrated into the core of the computer system 1800 by attachment to a system bus as described below (for example Ethernet interface into a PC computer system or cellular network interface into a smartphone computer system). Using any of these networks 1898, computer system 1800 can communicate with other entities. Such communication can be uni-directional, receive only (for example, broadcast TV), uni-directional send-only (for example CANbusto certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 1840 of the computer system 1800.

The core 1840 can include one or more Central Processing Units (CPU) 1841, Graphics Processing Units (GPU) 1842, a graphics adapter 1817, specialized programmable processing units in the form of Field Programmable Gate Areas (FPGA) 1843, hardware accelerators for certain tasks 1844, and so forth. These devices, along with Read-only memory (ROM) 1845, Random-access memory 1846, internal mass storage such as internal non-user accessible hard drives, SSDs, and the like 1847, may be connected through a system bus 1848. In some computer systems, the system bus 1848 can be accessible in the form of one or more physical plugs to enable extensions by additional CPUs, GPU, and the like. The peripheral devices can be attached either directly to the core's system bus 1848, or through a peripheral bus 1849. Architectures for a peripheral bus include PCI, USB, and the like.

CPUs 1841, GPUs 1842, FPGAs 1843, and accelerators 1844 can execute certain instructions that, in combination, can make up the aforementioned computer code. That computer code can be stored in ROM 1845 or RAM 1846. Transitional data can be also be stored in RAM 1846, whereas permanent data can be stored for example, in the internal mass storage 1847. Fast storage and retrieval to any of the memory devices can be enabled through the use of cache memory, that can be closely associated with one or more CPU 1841, GPU 1842, mass storage 1847, ROM 1845, RAM 1846, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 1800, and specifically the core 1840 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 1840 that are of non-transitory nature, such as core-internal mass storage 1847 or ROM 1845. The software implementing various embodiments of the present disclosure can be stored in such devices and executed by core 1840. A computer-readable medium can include one or more memory devices or chips, according to particular needs. The software can cause the core 1840 and specifically the processors therein (including CPU, GPU, FPGA, and the like) to execute particular processes or particular parts of particular processes described herein, including defining data structures stored in RAM 1846 and modifying such data structures according to the processes defined by the software. In addition or as an alternative, the computer system can provide functionality as a result of logic hardwired or otherwise embodied in a circuit (for example: accelerator 1844), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method performed by at least one processor, the method comprising:
forming one or more routers of a mixture of experts (MoE) model by computing router parameters based on a plurality of MoE weights;
implementing at least one of the routers of the MoE model to compute one or more outputs by using a number of the MoE weights less than that of the plurality of MoE weights; and
deriving an MoE expert based on iteratively updating the router parameters according to the one or more outputs.

2. The method according to claim 1,
wherein a first input layer of a first iteration of iteratively updating the router parameters comprises N=1 where N is a total number of the one or more routers.

3. The method according to claim 2,
wherein a total number of the plurality of MoE weights is n,
wherein a total number of the one or more outputs of the one or more routers is K and a total number of the MoE weights less than that of the plurality of MoE weights is k, and
wherein updating the router parameters according to the one or more outputs comprises updating the router parameters by replacing the total number of the plurality of MoE weights n total number of the MoE weights k less than that of the plurality of MoE weights n.

4. The method according to claim 2,
deriving the MoE expert further comprises estimating an output block index k by computing which of a plurality of blocks has a highest sum of activations.

5. The method according to claim 4,
wherein computing which of the plurality of blocks has the highest sum of activations is based on each of the plurality of blocks accumulated activations, a nonlinear activation function, the MoE weights, an input value of an input block, and a bias corresponding to the one or more outputs.

6. The method according to claim 5,
wherein each of the plurality of blocks accumulated activations is Sn k determined by
$${s}_{nk} = {\sum }_{j} f ( {\sum }_{i} {w}_{nk , ij} {x}_{n , i} + {b}_{nk , j} )$$
where f(.) represents the nonlinear activation function, W_{nk,ij} represents the MoE weights, X_{n,j} represents the input value of the input block, and b_{nk,j} represents the bias.

7. The method according to claim 1,
wherein the MoE expert is derived further based on a sum of activations of the MoE expert.

8. The method according to claim 7,
wherein the MoE expert is derived as one of a plurality of blocks of the MoE that is estimated as having a highest sum of activations among the plurality of blocks.

9. The method according to claim 1,
wherein the MoE expert is implemented in a large language model.

10. The method according to claim 1,
wherein the MoE expert is implemented in an image model.

11. An apparatus comprising:
at least one memory configured to store computer program code;
at least one processor configured to access the computer program code and operate as instructed by the computer program code, the computer program code including:
forming code configured to cause the at least one processor to form one or more routers of a mixture of experts (MoE) model by computing router parameters based on a plurality of MoE weights;
implementing code configured to cause the at least one processor to implement at least one of the routers of the MoE model to compute one or more outputs by using a number of the MoE weights less than that of the plurality of MoE weights; and
deriving code configured to cause the at least one processor to derive an MoE expert based on iteratively updating the router parameters according to the one or more outputs.

12. The apparatus according to claim 11,
wherein in a first input layer of a first iteration of iteratively updating the router parameters comprises N=1 where N is a total number of the one or more routers.

13. The apparatus according to claim 12,
wherein a total number of the plurality of MoE weights is n,
wherein a total number of the one or more outputs of the one or more routers is K and a total number of the MoE weights less than that of the plurality of MoE weights is k, and
wherein updating the router parameters according to the one or more outputs comprises updating the router parameters by replacing the total number of the plurality of MoE weights n total number of the MoE weights k less than that of the plurality of MoE weights n.

14. The apparatus according to claim 12,
deriving the MoE expert further comprises estimating an output block index k by computing which of a plurality of blocks has a highest sum of activations.

15. The apparatus according to claim 14,
wherein computing which of the plurality of blocks has the highest sum of activations is based on each of the plurality of blocks accumulated activations, a nonlinear activation function, the MoE weights, an input value of an input block, and a bias corresponding to the one or more outputs.

16. The apparatus according to claim 15,
wherein each of the plurality of blocks accumulated activations is Sn k determined by
$${s}_{nk} = {\sum }_{j} f ( {\sum }_{i} {w}_{nk , ij} {x}_{n , i} + {b}_{nk , j} )$$
wheref(.) represents the nonlinear activation function, W_{nk,ij} represents the MoE weights, X_{n,j} represents the input value of the input block, and b_{nk,j} represents the bias.

17. The apparatus according to claim 11,
wherein the MoE expert is derived further based on a sum of activations of the MoE expert.

18. The apparatus according to claim 17,
wherein the MoE expert is derived as one of a plurality of blocks of the MoE that is estimated as having a highest sum of activations among the plurality of blocks.

19. The apparatus according to claim 11,
wherein the MoE expert is implemented in one of a large language model and an image model.

20. A non-transitory computer readable medium storing a program causing a computer to:
form one or more routers of a mixture of experts (MoE) model by computing router parameters based on a plurality of MoE weights;
implement at least one of the routers of the MoE model to compute one or more outputs by using a number of the MoE weights less than that of the plurality of MoE weights; and
derive an MoE expert based on iteratively updating the router parameters according to the one or more outputs.
